(19) United States
(12) Patent Application Publication
(10) Pub. No.: US 2008/0171299 A1
(43) Pub. Date: Jul. 17, 2008

(54) Apparatus for Driving an Anchor of Straightening Teeth

(76) Inventor: Joong-Han Kim, Seoul (KR)

Correspondence Address: IPLA P.A., 3580 WILSHIRE BLVD., 17TH FLOOR, LOS ANGELES, CA, 90010, US

(21) Appl. No.: 10/595,367

(22) PCT Filed: Oct. 13, 2004
(86) PCT No.: PCT/KR2004/002607

§ 371 Date: Apr. 12, 2006

(30) Foreign Application Priority Data
Oct. 13, 2003 (KR) 10-2003-0071175

(51) Int. Cl. A61C 7/02

(52) U.S. Cl. 433/3

(57) ABSTRACT

The present invention relates to an apparatus for driving an anchor to support the orthodontic wire for correcting the twisted teeth by connecting a number of teeth in a body. The apparatus for driving an anchor comprises a fixed holding part which surrounds partly some space between a pair of two adjacent teeth and has a penetrated thread hole facing the side of the gum, a movable holding part which surrounds partly some space between a pair of two adjacent teeth by approaching to and getting away the fixed holding part and has a supporting protrusion which supports the side of protruding gum, an anchor position setting up part which determines the position at which the anchor is installed by being connected to at least one of the fixed holding part and the movable holding part, a adjusting screw which supports the side of the gum by being connected to the penetrated thread hole of the fixed holding part and adjusting the distance between the fixed holding part and the movable part. Accordingly, an anchor can be easily installed at a specific position regardless of the size of the gum

### TECHNICAL FIELD

The present invention relates to an apparatus for driving an anchor to support the orthodontic wire for correcting the twisted teeth by connecting a number of teeth in a body. The apparatus for driving an anchor comprises a fixed holding part which surrounds partly some space between a pair of two adjacent teeth and has a penetrated thread hole facing the side of the gum, a movable holding part which surrounds partly some space between a pair of two adjacent teeth by approaching to and getting away the fixed holding part and has a supporting protrusion which supports the side of protruding gum, an anchor position setting up part which determines the position at which the anchor is installed by being connected to at least one of the fixed holding part and the movable holding part, a adjusting screw which supports the side of the gum by being connected to the penetrated thread hole of the fixed holding part and adjusting the distance between the fixed holding part and the movable holding part. Accordingly, an anchor can be easily installed at a specific position regardless of the size of the gum

### BACKGROUND ART

Generally, in the orthodontic operations for malocclusion treatment, it is very important to adjust appropriately the interaction forces between moving teeth (mainly front teeth) and fixed teeth (mainly molars) in order to increase the mastication function of molars and pronunciation function and aesthetic point of view of front teeth. For example, in case of straightening the protruding teeth or the twisted teeth, when a front tooth moves toward the space prepared by removing a small molar, an orthodontic device comprising brackets adhered to teeth and an orthodontic wire connected between them is used. At that time, the orthodontic device brings about some interaction force at the front teeth in the direction of the molar. But, it is hard to move the front teeth to a specific position because the molars not to be moved shift forward and occupy the space by means of reaction force of opposite direction to the above mentioned interaction force. Thus, to reduce the reaction force and provide sufficient space for the moving teeth, an orthodontic device of mountable and dismountable (referred to headgear hereinafter) is installed at a tooth for the purpose of reinforcement of the anchor. But, aesthetic reason and annoyance of its mounting and dismounting several times results in poor effect of orthodontic treatment of headgear.

Accordingly, now a day, mini-implant (referred to anchor hereinafter), small screw, is driven into a position of the gum between two roots of teeth and then the teeth to be treated are fastened to it by using a elastic orthodontic wire for a reliable and continuos fixing method. This method has aesthetic advantage of not being easily noticed and has very fast orthodontic effect because of its heavy and continuos fixing strength. But, it is very difficult to drive the anchor into a correct position so that its driving depends on the experiences of dentists totally. Thus, the possibility of injury of the root of teeth resulted from the wrong driving of anchors is not low.

### DISCLOSURE OF INVENTION

### Technical Problem

The invention was conceived to solve the aforementioned problems. It is the first object of the invention to propose an apparatus for driving an anchor in order to drive an anchor easily into a specific position regardless of sizes and shapes of the gum.

### Technical Solution

The object can be obtained by the apparatus for driving an anchor, which comprises a fixed holding part which surrounds partly some space between a pair of two adjacent teeth and has a penetrated thread hole facing the side of the gum, a movable holding part which surrounds partly some space between a pair of two adjacent teeth by approaching to and getting away the fixed holding part and has a supporting protrusion which supports the side of protruding gum, an anchor position setting up part which determines the position at which the anchor is installed by being connected to at least one of the fixed holding part and the movable holding part, a adjusting screw which supports the side of the gum by being connected to the penetrated thread hole of the fixed holding part and adjusting the distance between the fixed holding part and the movable holding part. The fixed holding part and the movable holding part may be made into a body and have at least one elastic element. On the other hand, the fixed holding part and the movable holding part may be rotationally connected to a rotating shaft respectively and a pair of grips connected to the fixed holding part and the movable holding part respectively may be added so that they can adjust the distance between the fixed holding part and the movable holding part. Also an elastic element which excites the restoring force when the grips approach each other may be installed at the rotating shafts. On the other hand, a main body with a guiding thread of which connection with the movable holding part is sliding type at the same time of the fixation of the fixed holding part and a moving part which makes the movable holding part slide by means of thread connection with the guiding thread of the main body may be additionally included. And at least one grip prepared at the circumference of the moving part may be added so that the movable holding part can be easily moved near and away the fixed holding part by means of thread motion of the moving part.

### ADVANTAGEOUS EFFECTS

Like these, with apparatus for driving an anchor comprising a fixed holding part which is partly positioned at the point between two adjacent teeth and has a penetrated thread hole facing the side of the gum, a movable holding part which is partly positioned at the point between two adjacent teeth by approaching to and getting away the fixed holding part and has a supporting protrusion to support the side of protruding gum, and a adjusting screw which supports the side of the gum by being connected to the penetrated thread hole of the fixed holding part and adjusting the distance between the fixed holding part and the movable holding part, an anchor can be easily installed at a specific position regardless of the size of the gum

### DESCRIPTION OF DRAWINGS

Since the following drawings appended in this specification illustrate preferred embodiments of the invention and will serve to teach more the technical spirit of the invention together with the detailed description of the invention as will be described, the invention should not be limited to and construed only as depicted in the drawings.

FIG. 1 shows schematic configuration in which an orthodontic wire is installed at teeth.

FIG. 2 shows a schematic configuration of the apparatus for driving an anchor according to the first embodiment of present invention.

FIG. 3 shows a schematic configuration for the explanation of installation of apparatus for driving an anchor shown on FIG. 2.

FIG. 4 shows details of a part shown on FIG. 3.

FIG. 5 shows a schematic configuration of the apparatus for driving an anchor according to the second embodiment of present invention.

FIG. 6 shows a schematic configuration for the explanation of installation of apparatus for driving an anchor shown on FIG. 5

FIG. 7 shows a schematic configuration of the apparatus for driving an anchor according to the third embodiment of present.

FIG. 8 shows a schematic configuration of the apparatus for driving an anchor according to the forth embodiment of present.

FIG. 9 and FIG. 10 show schematic configuration for the explanation of operation of apparatus for driving an anchor shown on FIG. 8.

FIG. 11 shows a schematic configuration for the explanation of installation of apparatus for driving an anchor shown on FIG. 8.

FIG. 12 shows the section of XII-XII shown on FIG. 11

### BEST MODE

Hereinafter, preferred embodiments of the invention will be described in detail with referenced to the appended drawings.

Prior to the description, it should be noted that terms and words used in the description and claims must not be limited and interpreted to be typical or literal, and should be construed as the meaning and concept conforming to the technical spirit of the invention on the basis that the inventor can define the concept of the terms and Fords to describe the invention in a best way.

Accordingly, since the embodiments described in the present invention and configurations shown the drawings are the most preferred embodiments only and do not represent all of technical spirit of the invention, it should be understood that there may be various equivalents and modification examples that may replace them at the time of application of the present invention.

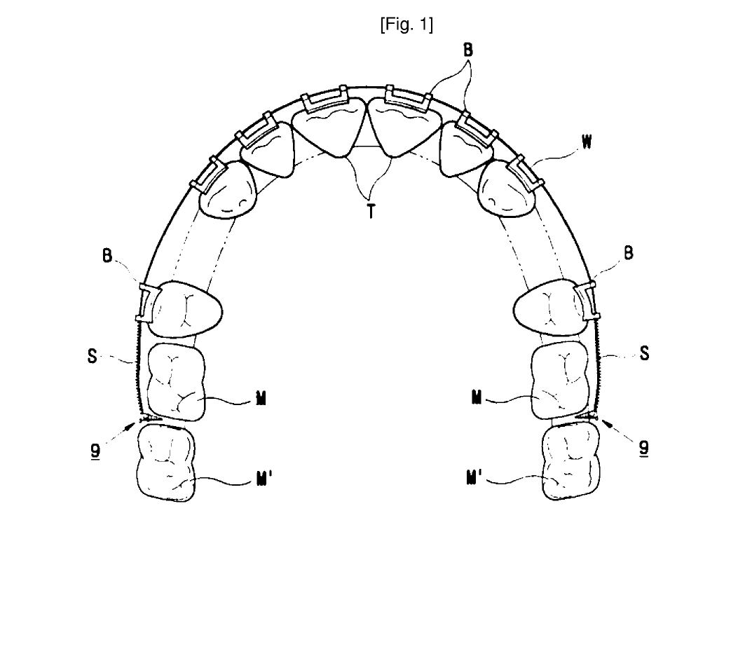

FIG. 1 shows roughly that the orthodontic wire W is installed to do an orthodontic treatment, the forced movement of a protruding front tooth F in the direction of the molars M and M′. At that time, instead of the orthodontic wire W, an elastic cord, a coil spring, etc., may be adopted.

There are same numbers of brackets corresponding to the teeth on the orthodontic wire W. And both ends of the orthodontic wire W are fixed using the anchor 9 driven at the field of the molars M, M′, which makes the protruding front tooth F be corrected by means of the movement of it in the direction of the molars M, M′. At this drawing, the bracket B near the anchor 9 is fixed by a coil spring S instead of the orthodontic wire W. At that time, the anchor 9 for fixing the orthodontic wire W should be driven into a specific position, a point of some space between the roots of a pare of the molars M, M′. In order to do this, the anchors 9 are driven into using the apparatus for driving an anchor.

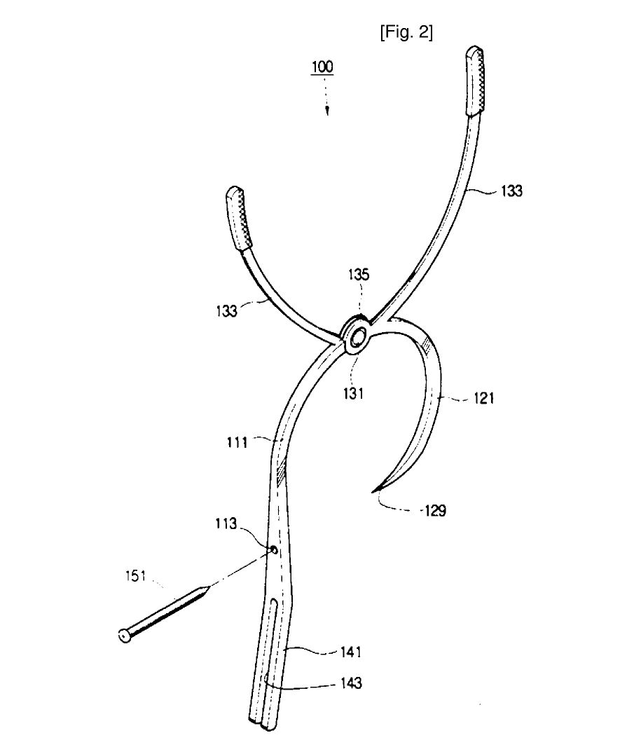

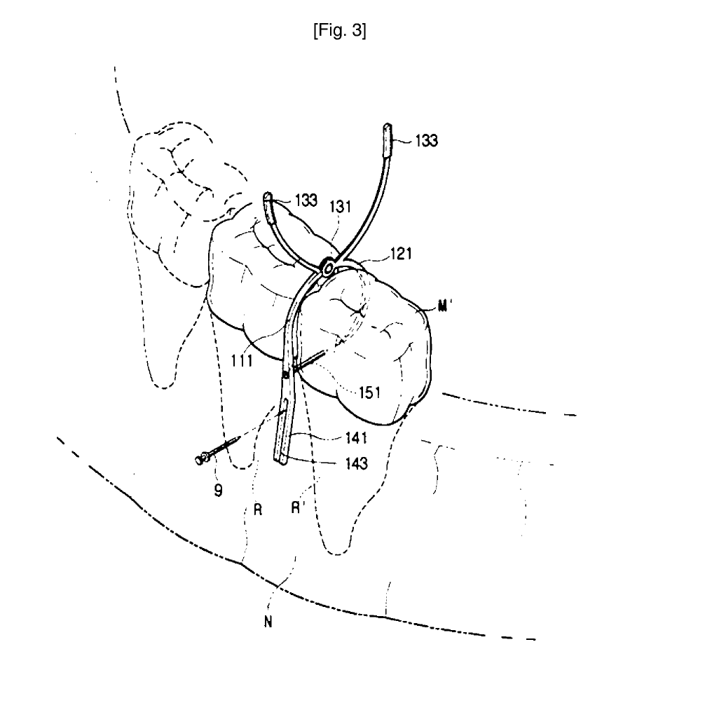

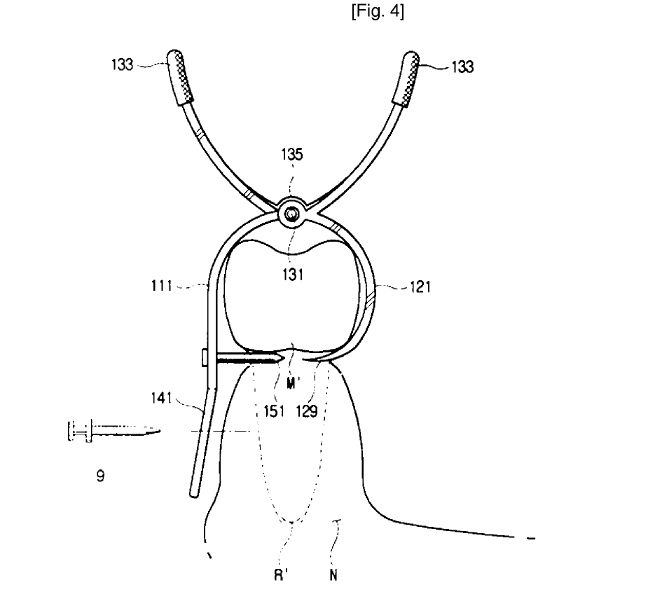

As shown on FIG. 2 to FIG. 4, the apparatus for driving an anchor 100 according to the first embodiment of this invention comprises the fixed holding part 111 which surrounds partly some space between a pair of two adjacent teeth and has a penetrated thread hole 113 facing the side of the gum N, the movable holding part 121 which surrounds partly some space between a pair of two adjacent teeth by approaching to and getting away the fixed holding part 111, the anchor position setting up part 141 which determines the position at which the anchor 9 is installed by being connected to at least one of the fixed holding part 111 and the movable holding part 121, and the adjusting screw 151 which supports the side of the gum N by being connected to the penetrated thread hole 113 of the fixed holding part 111 and adjusting the distance between the fixed holding part 111 and the movable holding part 121. The fixed holding part 111 and the movable holding part 121 have a convex shape to surround partly the space between two teeth.

There is the penetrated thread hole 113 facing the side of the gum N on the fixed holding part 111 and the adjusting screw 151 of mountable and dismountable type is connected to the penetrated thread hole 113. The adjusting screw 151 supports the side of the gum N by adjusting the distance from the supporting protrusion 129 of the movable holding part 121 to be mentioned below. The movable holding part 121 has the supporting protrusion 129 which protrudes from the inside and supports the side of the gum N corresponding to the penetrated thread hole 113 of the fixed holding part 111.

The adjusting screw 151 and the supporting protrusion 129 are prepared to determine the position of the anchor position setting up part 141 before the driving of anchor 9 and the position of the anchor position setting up part 141 can be determined by making the adjusting screw 151 move forward and backward following the penetrated thread hole 113 and adjusting the distance between the adjusting screw 151 and the supporting protrusion 129 regardless of the size of the gum N.

On the other hand, the fixed holding part 111 and the movable holding part 121 of the present embodiment are rotationally connected to the rotating shaft. And, a pair of grips 133 are connected to the fixed holding part 111 and the movable holding part 121 to adjust the distance between the fixed holding part 111 and the movable holding part 121. At this time, the grips 133 may be made into a body together with the fixed holding part 111 and the movable holding part 121 respectively or may be connected to the fixed holding part 111 and the movable holding part 121 by being separately manufactured. And, the elastic springs 135 which excite the restoring force proportional to the distance between the fixed holding part 111 and the movable holding part 121 are installed at the rotating shaft 131. Thus, if a dentist moves the grips each other, the fixed holding part 111 and the movable holding part 121 get wider with respect to the rotating shaft 131 and vice versa. At this time, the fixed holding part 111 and the movable holding part 121 surround partly some space between the two adjacent molars M, M′ in the perpendicular direction of molars' arrangement.

Also, the anchor position setting up part 141 is installed at the fixed holding part 111 and the movable holding part 121 respectively, which determines the driving position of the anchor 9 by being arranged at the side of the gum N. The anchor position setting up part 141 has the shape of a fork with the anchor insertion groove 143 of some length. The anchor position setting up part 141 can perform the function of vertical guide during the driving of anchor 9 because of its constant thickness. The anchor insertion groove 143 guides the driving position of the anchor 9.

According to the first embodiment of present invention with the above mentioned composition, the method for driving the anchor 9 can be described as below.

First of all, a pair of the grips 133 are approached each other after seizing them. Then, the fixed holding part 111 and the movable holding part 121 get wider with respect to the rotating shaft 131. The fixed holding part 111 and the movable holding part 121 surrounds partly some space between the two adjacent molars M, M′ in the perpendicular direction of molars' arrangement. At this time, the front part of the adjusting screw 151 and the supporting protrusion 129 are located between a pair of molars M, M′ and the gum N so that the front part of the adjusting screw 151 and the supporting protrusion 129 can be supported at the side of the gum N respectively by making the adjusting screw 151 move toward and backward with respect to the supporting protrusion 129, that is, by making the adjusting screw 151 move forward and backward with respect to the side of the gum N. Also, the anchor position setting up part 141 can be arranged at the side of the gum N corresponding to that.

And the dentist drives the anchor into a position of the gum N between the roots R, R′ of a pair of molars M, M′ by means of the anchor insertion groove 143.

Like this, according to the present invention, the anchor 9 can be easily driven into a specific position regardless of the size of gum.

### MODE FOR INVENTION

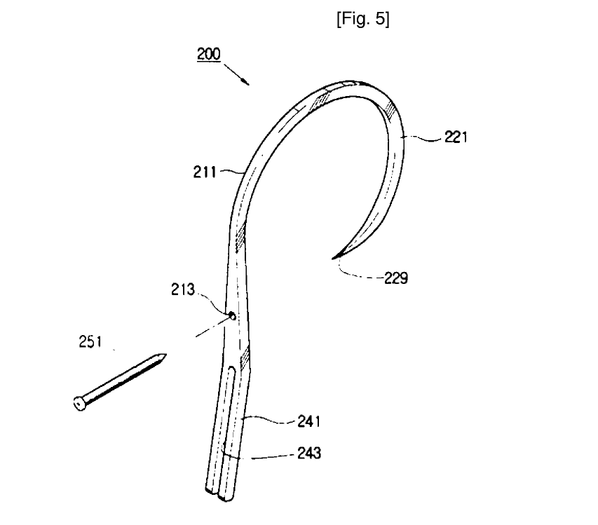

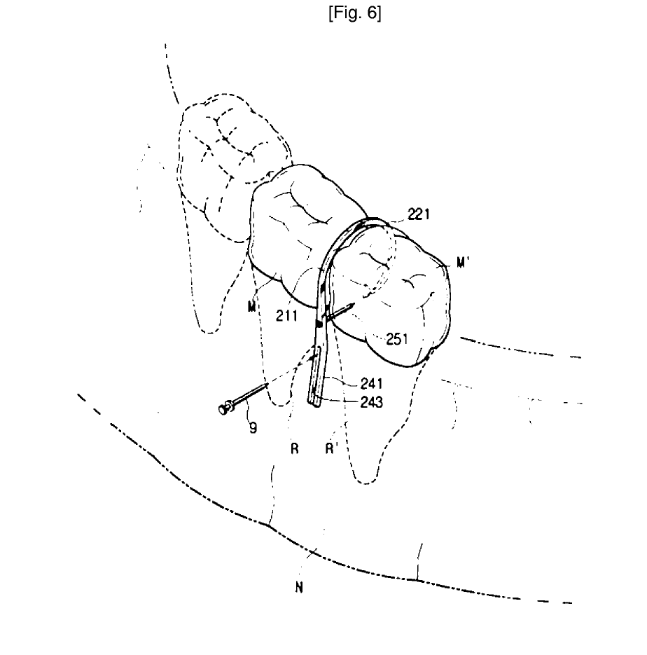

On the other hand, according to the first embodiment of the present invention, the grip 133 for dentist's seizing is prepared but, without the grip 133, there are no problems in the implementation of the technical spirit of present invention. That is, as shown on FIG. 5 and FIG. 6 describing the second embodiment of present invention, there are no grip at the apparatus for driving an anchor 200 contrary to the first embodiment described above and the fixed holding part 211 and the movable holding part 221 are made into a body contrary to the first embodiment in which they are rotationally connected with respect to the rotating shaft.

On the other hand, it is desired that the fixed holding part 211 and the movable part 221 are made with the elastic material such as plate type spring.

Accordingly, in case of using the apparatus for driving an anchor 200 according to the second embodiment, the dentist widens the both sides of the fixed holding part 211 and movable holding part 221 and arranges it a position of space between the molars M, M′. At this time, the front part of the adjusting screw 251 and the supporting protrusion 229 are located at a position between a pair of molars M, M′ and the gum N. Thus the front part of the adjusting screw 251 and the supporting protrusion 229 are supported at the side of the gum N respectively by making the adjusting screw 251 move toward and backward with respect to the side of the gum N conforming to the size of the gum N. And, a pair of the anchor position setting up parts 241 can be arranged at the side of the gum N by means of the radial shrinking of the fixed holding part 211 and the movable holding part 221 resulted from the removal of forces exerted on them.

And the dentist drives the anchor into a position of the gum N between the roots R, R′ of a pair of molars M, M′ by means of the anchor insertion groove 243 prepared at the anchor position setting up parts 241, thus anchor 9 can be easily driven into a specific position regardless of the size of the gum.

On the other hand, FIG. 7 shows a schematic configuration of the apparatus for driving an anchor according to the third embodiment of present. Contrary to the above described embodiments, the apparatus for driving an anchor 300 according to the third embodiment of present invention comprises the elastic shock absorber 339 of which part between the fixed holding part 311 and the movable holding part 321 is of circular arc shape.

The elastic shock absorber 339 functions as a grip when the fixed holding part 311 and the movable holding part 321 are arranged between a pair of molars and provides the elastic force so that the both sides of the fixed holding part 311 and the movable holding part 321 are easily widened. At this time, it is desired that the elastic shock absorber 339 is made with the elastic material such as plate type spring.

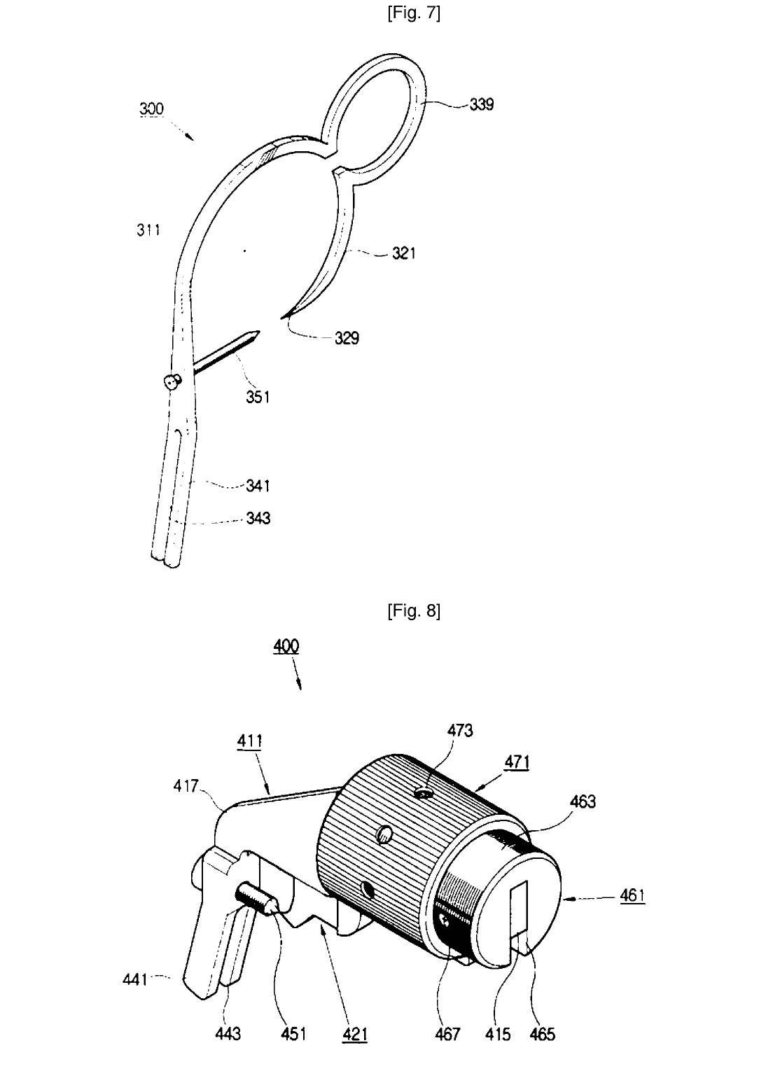

On the other hand, the apparatus for driving an anchor 400 according to the forth embodiment of present invention is described on FIG. 8 to FIG. 12. Contrary to the above described embodiments, the apparatus for driving an anchor 400 according to the forth embodiment of present invention comprises the main body 461 with the guiding thread 463 of which connection with the movable holding part 421 is sliding type at the same time of the fixation of the fixed holding part 411 and the moving part 471 which makes the movable holding part 421 slide by means of thread connection with the guiding thread 463 of the main body 461 additionally. The main body 461 has the shape of a cylinder and the guiding thread 463 to which the moving part 471 is connected is prepared at the circumference of the main body 461. The slit 465 to which the some part of the movable holding part 421 is connected are prepared in the longitudinal direction of the main body 461 with some depth. Also, the holding part 415 of the fixed holding part 411 is connected to the main body 461 through the fixing screw 467. At this time, it is desired that the fixing screw 467 is installed without protrusion outside the circumference of the main body 461 so as not to be interfered with the moving part 471. The fixed holding part 411 comprises the holding part 415 connected to the main body 461 and the teeth supporting part 417 which is extended from the one side of the holding part 415 and surrounds partly some space between a pair of adjacent teeth. The holding part 415 is installed at the main body 461 by being connected through the fixing screw 467.

The teeth supporting part 417 has the circular arc shape so that and it surrounds some space between a pair of adjacent teeth in the direction of perpendicular to the arrangement of the teeth. There is a penetrated thread hole to which the adjusting screw 451 of mountable and dismountable type is connected at the side of the tooth supporting part 417. The adjusting screw 451 adjusts the distance from the supporting protrusion 429 of the movable holding part 421 and supports the side of the gum N by being connected to the penetrated thread hole. Accordingly, the adjusting screw 451 supports the side of the gum N together with the supporting protrusion 429 of the tooth holding part 427 to be described below corresponding to the size of the gum N.

The anchor position setting up part 441 arranged at the side of the gum N determines the driving position of the anchor 9. The anchor position setting up part 441 has the shape of a fork with the anchor insertion groove 443 of some length. The anchor position setting up part 441 can perform the function of vertical guide daring the driving of anchor 9 because of its constant thickness. At this time, it is desired that anchor position setting up part 441 has the curved shape corresponding to the side of the gum N to decide the correct position for driving the anchor 9.

The movable holding part 421 comprises the sliding rod 423 of sliding connection type connected to the main body 461 and the tooth holding part 427 which is connected to the sliding rod 423 and surrounds partly some space between a pair of adjacent teeth together with the fixed holding part 411. The sliding rod 423 is connected to the slit 465 of the main body 461 and inside the moving part 471 simultaneously and slides according to the slit 465 of the main body 461 by means of the thread motion of the moving part 471. One side of the sliding rod 423 has the supporting projection 425 which supports the moving part 471 together with the tooth holding part 427. The tooth holding part 427 is extended from the one side of the sliding rod 423 in the moving direction of the sliding rod 423 and has the partly circular arc shape to surround some space between a pair of adjacent teeth together with the fixed holding part 411. The tooth holding part 427 protrudes from the inner part of the free end of the tooth holding part 427 opposite the adjusting screw 451 and has the supporting protrusion 429 to support the side of the gum N. Accordingly, the distance between the adjusting screw 451 and the supporting protrusion 429 can be adjusted corresponding to the size of the teeth to be treated and the gum N by approaching to and getting away the fixed holding part 411.

The moving part 471 with the hollow cylindrical shape is connected to the guiding thread 463 of the main body 461. The moving part 471 are supported by the one side of the tooth holding part 427 and the supporting projection 425 of the sliding rod 423 and the sliding rod 423 is supported by the inner part of the moving part 471. A female screw connected to the guiding thread 463 of the main body 461 is machined inside the moving part 471 and a seizing part for the thread motion with respect to the main body 461 are prepared outside the moving part 471. According to the present embodiment, as a seizing part, a number of the seizing groove 473 are machined outside the moving part 471 with some depth. Although not described here, other methods may be adopted as the seizing part.

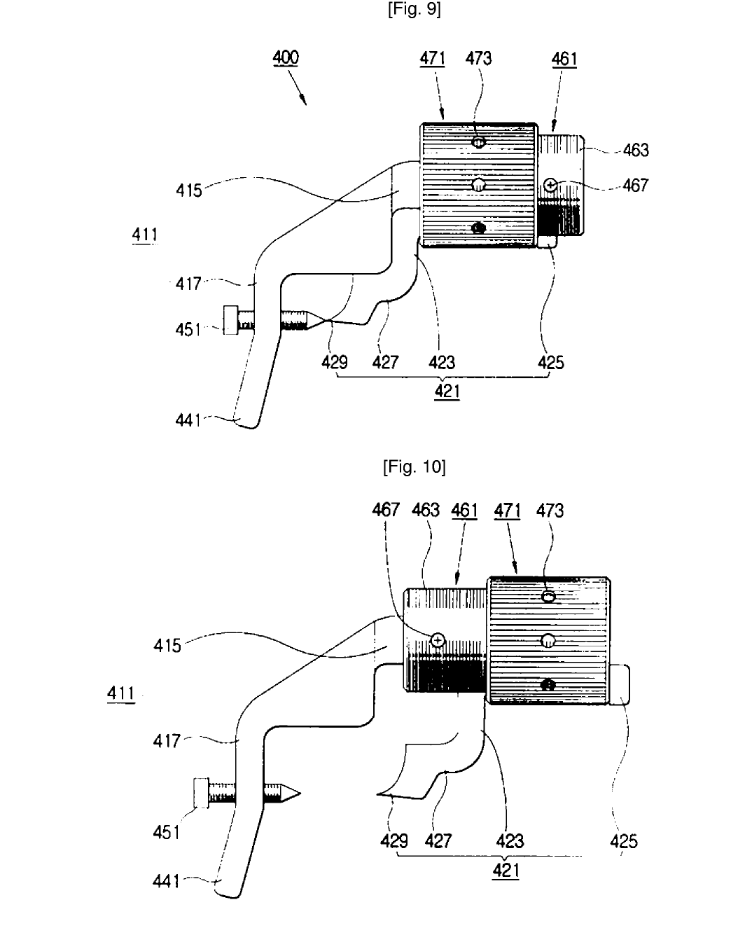

Accordingly, if the moving part 471 is rotated in one direction after seizing the seizing groove 473 of the moving part 471 by using a pincette, etc., the thread motion of the main body 461 and the moving part 471 makes the sliding rod 423 of the movable holding part 421 slide toward the tooth supporting part 417 of the fixed holding part 411 according to the slit 465 of the main body 461 so that the movable holding part 421 approaches to the fixed holding part 411 as shown on FIG. 9 and vice versa as shown on FIG. 10.

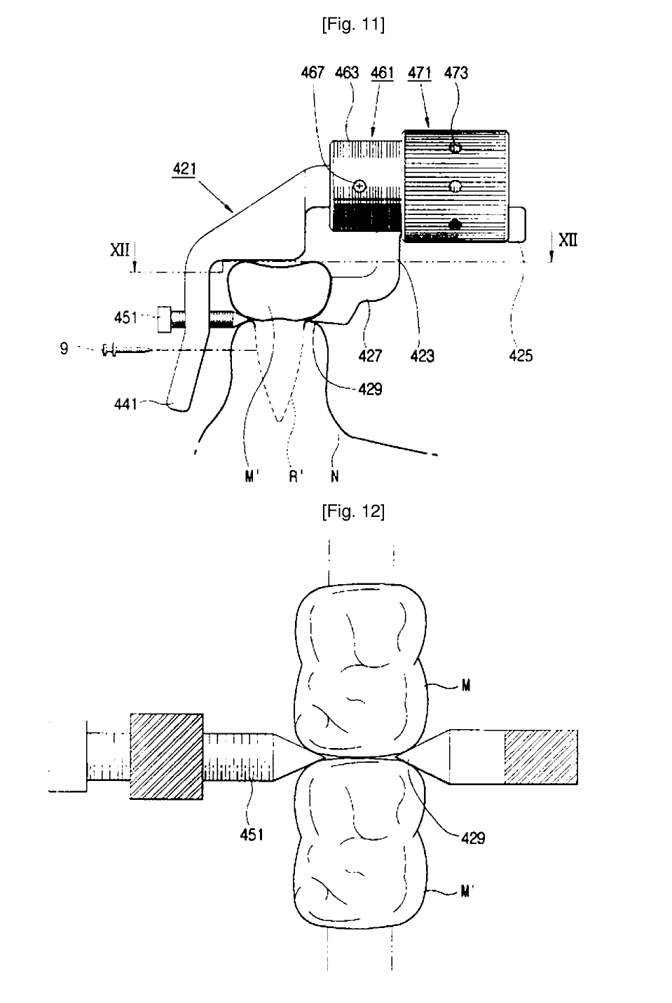

According to the forth embodiment of present invention with the above mentioned composition, the method for driving the anchor 9 can be described as below referring to FIG. 11 and FIG. 12

The apparatus for driving an anchor 400 is arranged between a pair of two adjacent molars M, M′ in the perpendicular direction of the arrangement of the teeth T and, at this time, the anchor position setting up part 441 is disclosed outside the mouth. Then, if the moving part 471 is rotated in one direction after seizing the seizing groove 473 of the moving part 471 by using a pincette, etc., the thread motion of the main body 461 and the moving part 471 makes the sliding rod 423 of the movable holding part 421 slide toward the tooth supporting part 417 of the fixed holding part 411 according to the slit 465 of the main body 461 so that the movable holding part 421 approaches to the fixed holding part 411. Thus, the fixed holding part 411 and the movable holding part 421 surround some space between a pair of teeth and the front part of the adjusting screw 451 of the fixed holding part 411 and the supporting protrusion 429 are located between a pair of the molars M, M′ and the gum N. At this time, the front part of the adjusting screw 451 and the supporting protrusion 429 can be supported at the side of the gum N respectively by making the adjusting screw 451 move toward and backward with respect to the supporting protrusion 429, that is, by making the adjusting screw 451 move toward and backward with respect to the side of the gum N. Also, the anchor position setting up part 441 can be arranged at the side of the gum N corresponding to that.

And the dentist drives the anchor 9 into a position of the gum N between the roots R, R′ of a pair of molars M, M′ by means of the anchor insertion groove 443.

On the other hand, the anchor position setting up part is installed at the fixed holding part in the above described embodiments bit it may be installed at the movable holding part. Also, although not described in the embodiment, the anchor position setting up part of mountable and dismountable type may be connected to any between the fixed holding part and the movable holding part.

### INDUSTRIAL APPLICABILITY

As described above, an orthodontic anchor can be easily installed at a specific position regardless of the size of the gum

1. An apparatus for driving an anchor in order to fix the orthodontic wire for correcting the twisted teeth comprising:
a fixed holding part which is partly positioned at the point between two adjacent teeth and has a penetrated thread hole facing the side of the gum;
a movable holding part which is partly positioned at the point between two adjacent teeth by approaching to and getting away the fixed holding part and has a supporting protrusion to support the side of protruding gum;
an anchor position setting up part which determines the position at which the anchor is installed by being connected to at least one of the fixed holding part and the movable holding part;
a adjusting screw which supports the side of the gum by being connected to the penetrated thread hole of the fixed holding part and adjusting the distance between the fixed holding part and the movable part.

2. An apparatus for driving an anchor according to claim 1, wherein the fixed holding part and the movable holding part are made into a body and has at least one elastic element allowing them to approach to both sides of a pair of teeth respectively.

3. An apparatus for driving an anchor according to claim 1, the fixed holding part and the movable holding part are rotationally connected to the rotating shaft respectively.

4. An apparatus for driving an anchor according to claim 3, wherein a pair of grips connected to the fixed holding part and the movable holding part respectively are farther added so that they can adjust the distance between the fixed holding part and the movable holding part.

5. An apparatus for driving an anchor according to claim 4, wherein the rotating shaft comprises an elastic element which excites the restoring force when the grips approach.

6. An apparatus for driving an anchor according to claim 1, the apparatus farther comprises:
a main body with a guiding thread of which connection with the movable holding part is sliding type at the same time of the fixation of the fixed holding part;
and a moving part which makes the movable holding part slide by means of thread connection with the guiding thread of the main.

7. An apparatus for driving an anchor according to claim 6, the moving part further comprises at least one grip prepared at the circumference of the moving part for its thread motion with respect to the main body.
